(19) United States
(12) Patent Application Publication
(10) Pub. No.: US 2007/0001446 A1
(43) Pub. Date: Jan. 4, 2007

(54) Pipe connecting structure of heat exchanger

(75) Inventors: Masayoshi Shinhama, Tokyo (JP); Masakazu Takizawa, Tokyo (JP)

Correspondence Address: FOLEY AND LARDNER LLP;SUITE 500, 3000 K STREET NW, WASHINGTON, DC, 20007, US

(73) Assignee: CALSONIC KANSEI CORPORATION

(21) Appl. No.: 11/443,010

(22) Filed: May 31, 2006

(30) Foreign Application Priority Data
May 31, 2005 (JP) 2005-159120

(51) Int. Cl. F16L 41/00

(52) U.S. Cl. 285/125.1

(57) ABSTRACT

A pipe connecting structure has a connector block fixed to a header tank of a heat exchanger and formed with a through-hole and a large diameter hole, a header side pipe having a base end portion connected with the header tank and a diameter expansion portion formed at its top portion and inserted into the large diameter hole of the connector block, and a vehicle side pipe having an end portion connected with a vehicle side device and a top portion inserted into the diameter expansion portion of the header side pipe through the through hole. The diameter expansion portion of the header pipe is brazed to the connector block, and the top portion of the vehicle side pipe is fixed to the connector block with a seal member between the connector block and the top portion of the vehicle side pipe.

### BACKGROUND OF THE INVENTION

1. Field of the Invention

The present invention relates to a pipe connecting structure of a heat exchanger, in which a header side pipe of a heat exchanger and a vehicle side pipe of a device, such as an engine or an air conditioner, are independently inserted in a connector block to be joined with each other to flow heat transfer medium between them.

2. Description of the Related Art

A conventional pipe connecting structure of a heat exchanger is disclosed in Japanese Patent Applications Laid-open No. 2001-133191 and No. 2004-347210.

These pipe connecting structures are provided on a side portion of a heat exchanger including a plurality of tubes and corrugated fins, which are arranged alternatively and between a left header tank and a right header tank. The left and right header tanks are fluidically connected with left and right end portions of the tubes, respectively. At least one of the left and right header tanks is connected with a header side pipe, which is further fluidically connected with a vehicle side pipe by using a connector block. The connector block is formed with two holes for respectively receiving end portions of the header side pipe and the vehicle side pipe. Theses two holes are formed in parallel with each other and perpendicular to the left and right header tanks in the former conventional pipe structure, and they are formed in series in the latter conventional pipe structure.

The above known conventional pipe connecting structures of the heat exchanger, however, encounter problems in that the connector block with the holes for receiving the header side pipe and the vehicle side pipe requires a large size for forming them, because they are formed independently from each other in parallel or series. This results in cost increase and weight increase.

Incidentally, the connector block is fixed on the header tank normally by using blazing. In order to blaze them sufficiently for ensuring necessary supporting stiffness, the connector block is preferable to be lighter in weight as possible. From this view, it is important to decrease the weight of the connector block.

FIGS. 5 and 6 show a part of a heat exchanger with a conventional pipe connecting structure, similar to the latter one described above. The heat exchanger includes a header tank 102 and a heat exchanger core 103 having a plurality of tubes 103a and corrugated fins 103b arranged alternatively. The pipe connecting structure has a connector block 109 fixed to the header tank 102, a header side pipe 110 brazed to the connecter block 109 and a vehicle side pipe 111 with an adapter 112 inserted in the connector block 109 as a top portion of the vehicle side pipe 111. The header side pipe 110 and the vehicle side pipe 111 are arranged in series in the connector block 109. A vertical length of an inserted portion of the adapter 12 is D1, and a vertical length of an inserted portion of the header side pipe 110 is D2 as shown in FIG. 5. Accordingly, a vertical length D3, shown in FIG. 6, of the connector block 109 becomes larger than the total length (D1+D2) of the header side pipe 110 and the adapter 112, since the inserting portions do not overlap with each other in a vertical direction. This is the reason the connector block 109 becomes larger and heavier.

It is, therefore, an object of the present invention to provide a pipe connecting structure of a heat exchanger which overcomes the foregoing drawback and can downsize a connector block for fluidically connecting a header side pipe and a vehicle side pipe with each other, decreasing its material cost and weight.

### SUMMARY OF THE INVENTION

According to a first aspect of the present invention there is provided a pipe connecting structure of a heat exchanger having a header tank. The pipe connecting structure comprises a connector block fixed to the header tank and formed with a through-hole and a large diameter hole at one side thereof, the through-hole and the large diameter hole being formed continuously to flow cooling medium therethrough, a header side pipe having a base end portion fluidically connected with the header tank and a diameter expansion portion formed at a top portion thereof and inserted into the large diameter hole of the connector block, and a vehicle side pipe having an end portion fluidically connected with a vehicle side device and a top portion formed at another end portion thereof and inserted into the diameter expansion portion of the header side pipe through the through hole. The diameter expansion portion of the header side pipe is brazed to the connector block, and the top portion of the vehicle side pipe is fixed to the connector block with a seal member disposed between the connector block and the top portion of the vehicle side pipe.

Therefore, this pipe connecting structure can downsize a connector block for fluidically connecting a header side pipe and a vehicle side pipe with each other, decreasing its material cost and weight.

Preferably, the connector block is formed with a tapered hole at the other side of the connector block, the tapered hole being fluidically connected with the through-hole.

Therefore, the top portion of the vehicle side pipe can be easily inserted into the through-hole of the connector block by sliding it along an inner wall forming the tapered hole.

Preferably, the seal member is positioned in the through-hole of the connector block.

Therefore, the seal member ensures a tight sealing of the pipe connecting structure.

Preferably, the top portion of the vehicle side pipe is formed by an adapter connected with the vehicle side pipe and having a large diameter portion for preventing the adapter to pass through the connecter block and a cylindrical portion insertable into the through-hole of the connector block and the diameter expansion portion of the header side pipe.

Therefore, the top portion of the vehicle side pipe can be easily formed at low cost.

### BRIEF DESCRIPTION OF THE DRAWINGS

The objects, features and advantages of the present invention will become apparent as the description proceeds when taken in conjunction with the accompanying drawings, in which:

FIG. 1 is a front view showing a heat exchanger with a pipe connecting structure of a first embodiment according to the present invention;

FIG. 2 is an enlarged and exploded partial view showing the pipe connecting structure and its peripheral portion, which are indicated by a circle AC in FIG. 1, of the heat exchanger of the first embodiment;

FIG. 3 is an enlarged partial view showing the pipe connecting structure and its peripheral portion, shown in FIG. 2, of the heat exchanger of the first embodiment shown in FIG. 1;

FIG. 4 is a front view showing a heat exchanger with a pipe connecting structure of a second embodiment according to the present invention;

FIG. 5 is an enlarged partial view showing a pipe connecting structure and its peripheral portion of a heat exchanger of prior art; and

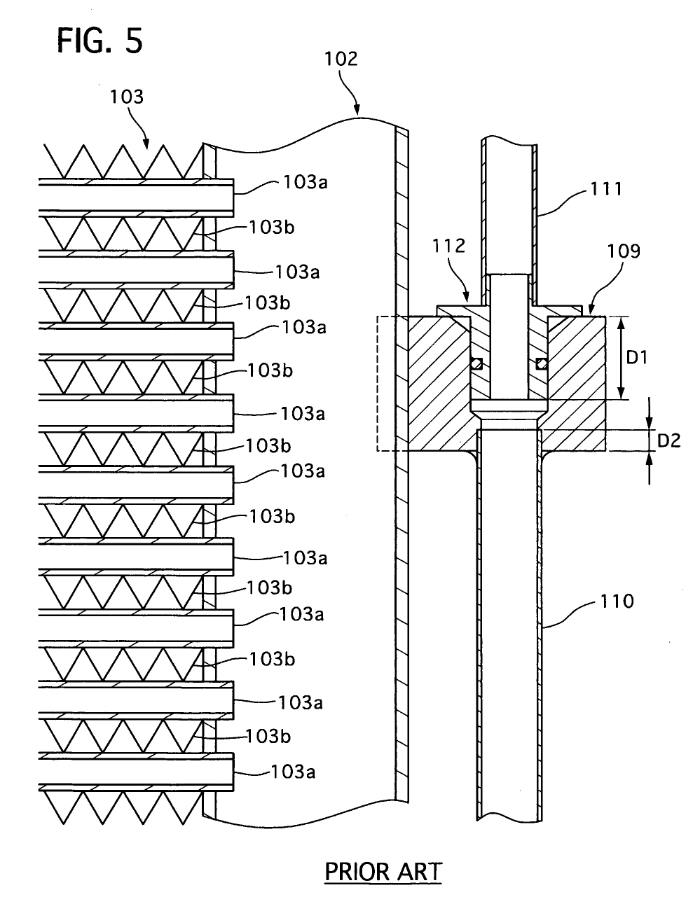

FIG. 6 is an enlarged and exploded partial view showing the pipe connecting structure and its peripheral portion of the heat exchanger of the prior art shown in FIG. 5.

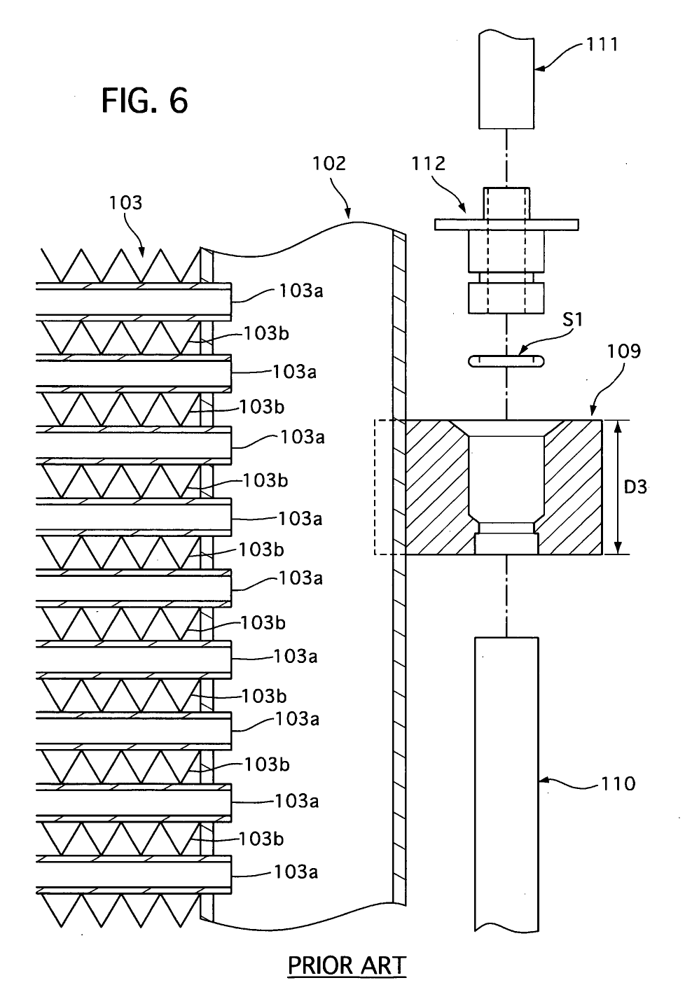

### DETAILED DESCRIPTION OF THE PREFERRED EMBODIMENTS

Throughout the following detailed description, similar reference characters and numbers refer to similar elements in all figures of the drawings, and their descriptions are omitted for eliminating duplication.

Hereinafter, embodiments of the present invention will be described with reference to the accompanying drawings.

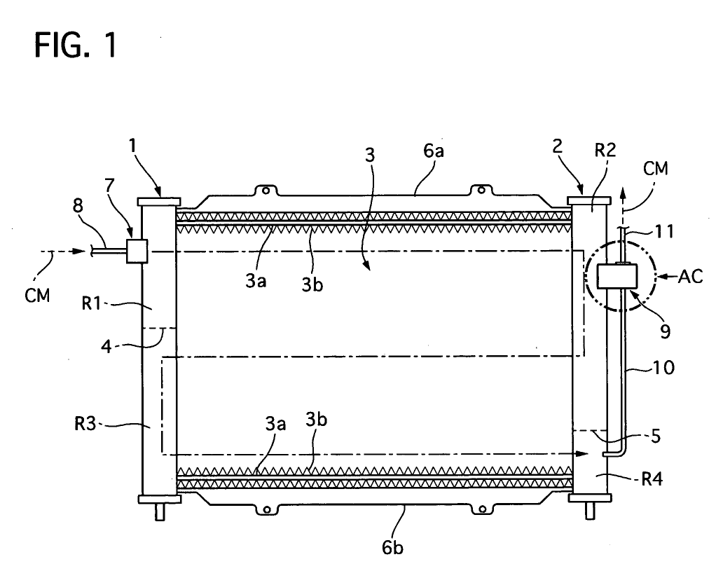

Referring to FIG. 1, there is shown a condenser with a heat exchanger core 3 and a pair of header tanks 1 and 2. The condenser is used for air conditioning in the interior of a motor vehicle and corresponds to a heat exchanger of the present invention.

The heat exchanger core 3 has a plurality of tubes 3a and corrugated fins 3b, which are arranged alternatively with each other. The tubes 3a are fluidically connected with the right and left header tanks 1 and 2 at their both end portions, respectively to flow refrigerant in them. Note that the right and left header tanks 1 and 2 are shown at a left side and a right side in FIG. 1, respectively, since FIG. 1 is a front view of the condenser. The refrigerant is HFC 134a or CO₂ for example, and corresponds to cooling medium of the present invention.

Upper portions of the right and left header tanks 1 and 2 are joined by an upper reinforcement member 6a, and lower portions of them are also joined by a lower reinforcement member 6b.

The right and left header tanks 1 and 2 are formed in a circular cylinder shape. A right partition plate 4 defines an interior portion of the right header tank 1 into a first room R1 and a third room R3, and a left partition plate 5 defines an interior portion of the left header tank 2 into a second room R2 and a fourth room R4. This enables the refrigerant to flow through the first room R1, the second room R2, the third room R3, and the fourth room R4 in this order, along an arrow indicated by an alternate long and short line.

The first room R1 is fluidically connected with a first vehicle side pipe 8 to be supplied with the cooling medium therefrom through a first connector block 7, which is fixed on the right header tank 1 by brazing. The first vehicle side pipe 8 is connected with a not-shown compressor.

On the other hand, the fourth room R4 is fluidically connected with a header side pipe 10. The header side pipe 10 is fluidically connected with a second vehicle side pipe 11 through a second connector block 9, which is fixed on the left header tank 2 by brazing. The second vehicle side pipe 11 is connected with a not-shown receiver, expansion valve, and evaporator. The second vehicle side pipe 11 corresponds to a vehicle side pipe of the present invention, and the second connector block 9 corresponds to a connector block of the present invention.

All parts of the condenser of the first embodiment are made of aluminum, and at least one connecting portion of mutually connecting portions, to be treated with heat, of them is provided with a cladding layer (a brazing sheet).

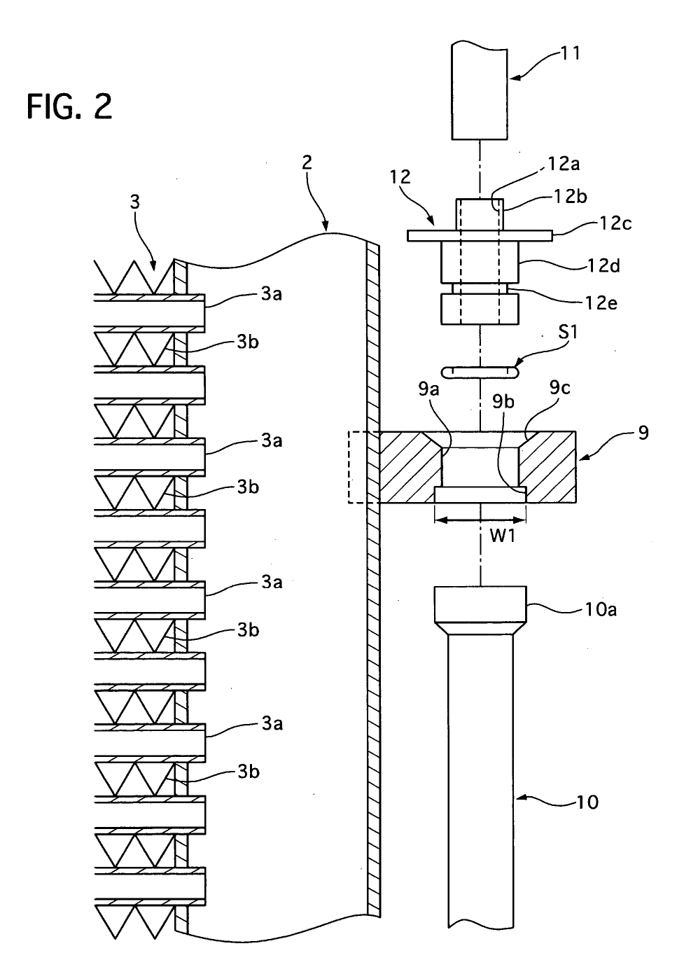

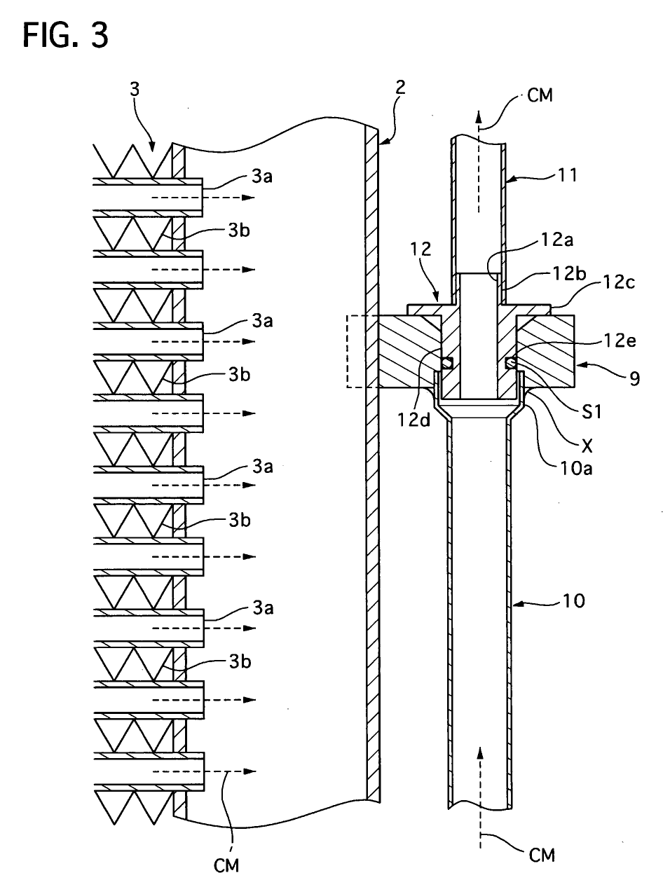

The pipe connecting structure of the first embodiment is shown in FIGS. 2 and 3. It has the header side pipe 10, the second vehicle side pipe 11, the second connector block 9, a seal member S1, and an adapter 12.

The second connector block 9 is fitted to and fixed on an outer surface of the left header tank 2 by brazing. The second connector block 9 is formed with a through-hole 9a with a large diameter hole 9b at its lower side and with a tapered hole 9c at its upper side. The large diameter hole 9b is formed to have a diameter W1 larger than that of the through-hole 9a, and the tapered hole 9c is formed to slightly increase its diameter towards a top surface of the second connector block 9.

A base end portion of the header side pipe 10 is fixed on the left header tank 2 by blazing to fluidically communicate with the fourth room R4, and a top portion thereof is formed to be a diameter expansion portion 10a with a diameter substantially equal to but slightly smaller than the diameter W1 of the through-hole 9a so that the diameter expansion portion 10a can be fitted in the through-hole 9a.

The second vehicle side pipe 11 is joined with the adapter 12 at its one end portion so that the adapter 12 is a part of the second vehicle side pipe 11 to function as a top portion thereof Accordingly, the adapter 12 may be integrally formed with the second vehicle side pipe 11. The adapter 12 corresponds to an adapter of the present invention, and also a top portion of a vehicle side pipe of the present invention.

The adapter 12 is formed in a circular cylinder shape with a through-hole 12a extending along a not-shown center axis thereof to pass the refrigerant therethrough. The adapter 12 has a connecting portion 12a, a large diameter portion 12c, and a cylindrical portion 12d, which are integrally formed in this order.

The connecting portion 12b is formed in a circular cylinder shape having a diameter substantially equal to but slightly smaller than an inner diameter of the second vehicle side pipe 11 so that the connecting portion 12a can be inserted and fitted into the second vehicle side pipe 11.

The large diameter portion 12c is formed like a disc having a diameter larger than the largest diameter of the tapered hole 9c of the second connector block 9 so that it can prevent the adapter 12 to pass through the tapered hole 9c.

The cylindrical portion 12d is formed so that it can be inserted into the through-hole 9a and the diameter expansion portion 10a of the header pipe 10. The cylindrical portion 12d is also formed with a seal groove on its outer surface at its intermediate position so as to receive the seal member S1 shaped like a ring. The seal member S1 is set to block a gap between the outer surface of the cylindrical portion 12d and an inner wall defining the through-hole 9a as shown in FIG. 3, when the pipe connecting structure is assembled.

As shown in FIG. 3, the diameter expansion portion 10a of the header side pipe 10 and the second connector block 9 are brazed integrally to each other with brazing filler metal X in a state where the diameter expansion portion 10a is inserted in the large diameter hole 9b of the second connector block 9. The adapter 12, as the top portion of the second vehicle side pipe 11, is inserted and fitted into the through-hole 9a of the second connector block 9 and the diameter expansion portion 10a of the header side pipe 10 in a sealing state by using the seal member S1 disposed between the inner wall of the second connector block 9 and the seal groove 12e of the adapter 12 so as to flow the cooling medium CM between the header side pipe 10 and the second vehicle side pipe 11.

The condenser with the pipe connecting structure of the first embodiment is assembled as follows.

The right and left header tanks 1 and 2 and the heat exchanger core 3 are temporally assembled. Then, the first connector block 7 is temporally mounted on the right header tank 1, and the second connector block 9, the header side pipe 10 and the left header tank 2 are temporally assembled. These temporary assemblies are integrally formed into the condenser with the pipe connecting structure by brazing in a not-shown heat treatment furnace in a heat treatment process.

In this heat treatment process, the second connector block 9 is fixed to the left header tank 2 by brazing, and the diameter expansion portion 10a of the header side pipe 10 is also fixed to the second connector block 9 by the brazing filler metal X at their contacting portions all around the diameter expansion portion 10a.

The condenser mounted on the motor vehicle is fluidically connected with a vehicle side device such as a compressor through the first vehicle side pipe 8, whose top portion is connected with the first connector block 7.

The condenser mounted is fluidically connected with the vehicle side device such as the expansion valve and the evaporator through the second vehicle side pipe 11, whose top portion, the adapter 12, is inserted into the through-hole 9a of the second connector block 9 up to a position where the large diameter portion 12c contacts on the top surface of the second connector block 9, and press-fitted in it. The adapter 12 can be easily inserted into the second connector block 9 due to its tapered hole 9c by sliding the adapter 12 along a slope surface forming the tapered hole 9c.

In this connecting state of the second vehicle side pipe 11 and the second connector block 9, the seal member S1 keeps a tight seal of a gap formed between the adapter 12 and the second connector block 9. Note that the diameter expansion portion 10a overlaps a part of the adapter 12 in a vertical direction in this connecting state.

The operation of the condenser with the pipe connecting structure of the first embodiment will be described.

In this condenser, the cooling medium CM is supplied through the first vehicle side pipe 8 and the first connector block 7 into the first room R1. Then, it flows along the arrow indicated by the alternative long and short dash line shown in FIG. 1; through the tubes 3 between the first room R1 and the second room R2 to the second room R2, and then through the tubes 3a between the second room R2 and the third room R3 to the third room R3, and then through the tubes 3a between the third room R3 and the fourth room R4 to the fourth room R4. The cooling medium CM in the fourth room R4 is discharged into the second vehicle side pipe 11 through the adapter 12 in the second connector block 9.

While the cooling medium CM flows in the tubes 3a, its heat is released through the fins 3b, which is hit by the air supplied from a not-shown motor fan and/or caused while the motor vehicle is running. As a result, the cooling medium CM is cooled.

The pipe connecting structure of the first embodiment has the following advantages.

The diameter expansion portion 10a of the header side pipe 10 is inserted into the second connector block 9, and a part of the adapter 12 functioning as the top portion of the vehicle side pipe 11 is inserted into the diameter expansion portion 10a so as to overlap with each other. Therefore, the vertical length of the second connector block 9 can be decreased by their overlapped portions, thereby being smaller and lighter. In addition, the large diameter hole 9b and the tapered hole 9c also decrease the weight of the second connector block 9. These volume reductions of the second connector block 9 can decrease material necessary for forming the second connector block 9 and provide sufficient stiffness for supporting the second connector block 9 on the left header tank 2.

The adapter 12 can be easily inserted into the through-hole 9a by sliding it along the slope surface forming the tapered hole 9c.

The seal member S1 is disposed on the cylindrical portion 12d positioned at an end portion side the adapter 12 relative to the large diameter portion 12c so that the seal member S1 is located between the diameter expansion portion 10a of the header side pipe 10 and the large diameter portion 12c, that is in the through-hole 9a, contacting with the inner wall forming the through-hole 9a. This can ensure a tight sealing of the gap formed between the inner wall of the second connector block 9 and the cylindrical portion 12d of the adapter 12.

The adapter 12 and the second vehicle side pipe 11 are formed independently from each other at the first stage, and then they are joined to have a desired top portion of the second vehicle side pipe 11. This enables the top portion of the second vehicle side pipe 11 to be easily formed at low cost.

A heat exchanger with a pipe connecting structure of a second embodiment will be described with reference to the accompanying drawing.

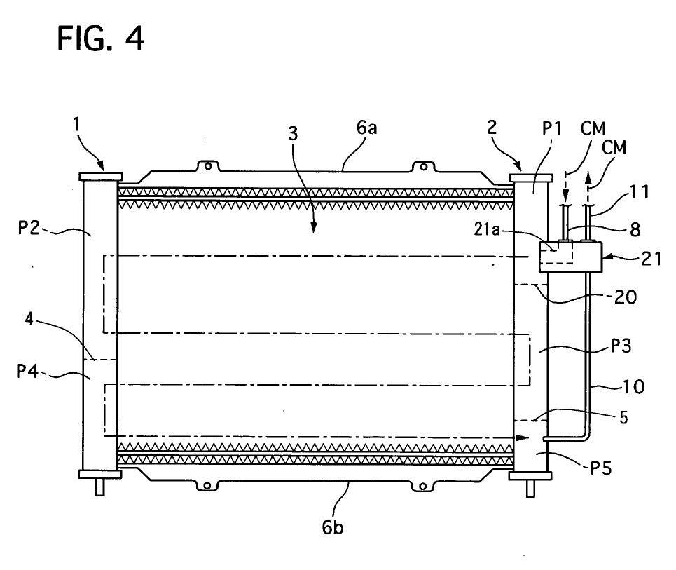

Referring to FIG. 4, there is shown the heat exchanger wit the pipe connecting structure of the second embodiment.

A condenser as the heat exchanger includes a right header tank 1, a right header tank 2, an upper reinforcement member 6a, a lower reinforcement member 6b and a heat exchanger core 3.

An inner portion of the left header tank 1 is separated by a first partition plate 4 into a second room P2 and a fourth room P4. An inner portion of the right header tank 2 is separated by a second partition plate 5 and a third partition plate 20 into a first room P1, a third room P3 and a fifth room P5. The pipe connecting structure has a header side pipe 10, a first vehicle side pipe 8, a second vehicle side pipe 11 and a connector block 21. The second vehicle side pipe 11 corresponds to a vehicle side pipe of the present invention. The connector block 21 is formed with an L shaped hole 21a for fluidically connecting the first vehicle side pipe 8 and the first room P1 in addition to the similar structure of the first embodiment shown in FIGS. 2 and 3. Specifically, the connector block 21 fluidically connects the second vehicle side pipe 11 and the header side pipe 10 connected with the fifth room P5.

Note that the first connector block 8 in the first embodiment is eliminated in this second embodiment.

The other parts in the second embodiment are similar to those in the first embodiment.

Accordingly, cooling medium CM flows along an arrow indicated by an alternative long and short dash line.

This pipe connecting structure of the second embodiment has an operation and advantages similar to those of the first embodiment.

As understood from two embodiments, a flow direction of the cooling medium CM, a configuration of the connector blocks 9 and 21, and a connecting direction of the vehicle side pipes 8, 11 can be set arbitrarily.

While the invention has been particularly shown and described with reference to preferred embodiments thereof, it will be understood by those skilled in the art that the foregoing and other changes in form and details can be made therein without departing from the spirit and scope of the invention.

For example, although the through-hole 9a, the large diameter hole 9b and the tapered hole 9c is formed in the vertical direction in the first and second embodiments, they may be formed an arbitrary direction.

The heat exchanger of the present invention is not limited to the condenser in the embodiments, and includes a radiator fluidically connected with an engine to cool it and the like.

The entire contents of Japanese Patent Application No. 2005-159120 filed May 31, 2005 are incorporated herein by reference.

What is claimed is:

1. A pipe connecting structure of a heat exchanger having a header tank, the pipe connecting structure comprising:
a connector block fixed to the header tank and formed with a through-hole and a large diameter hole at one side thereof, the through-hole and the large diameter hole being formed continuously to flow cooling medium therethrough;
a header side pipe having a base end portion fluidically connected with the header tank and a diameter expansion portion formed at a top portion thereof and inserted into the large diameter hole of the connector block; and
a vehicle side pipe having an end portion fluidically connected with a vehicle side device and a top portion formed at another end portion thereof and inserted into the diameter expansion portion of the header side pipe through the through hole, wherein
the diameter expansion portion of the header side pipe is brazed to the connector block, and the top portion of the vehicle side pipe is fixed to the connector block with a seal member disposed between the connector block and the top portion of the vehicle side pipe.

2. The pipe connecting structure of claim 1, wherein
the connector block is formed with a tapered hole at the other side of the connector block, the tapered hole being fluidically connected with the through-hole.

3. The pipe connecting structure of claim 2, wherein
the seal member is positioned in the through-hole of the connector block.

4. The pipe connecting structure of claim 3, wherein
the top portion of the vehicle side pipe is formed by an adapter connected with the vehicle side pipe and having a large diameter portion for preventing the adapter to pass through the connecter block and a cylindrical portion insertable into the through-hole of the connector block and the diameter expansion portion of the header side pipe.

5. The pipe connecting structure of claim 1, wherein
the seal member is positioned in the through-hole of the connector block.

6. The pipe connecting structure of claim 5, wherein the top portion of the vehicle side pipe is formed by an adapter connected with the vehicle side pipe and having a large diameter portion for preventing the adapter to pass through the connecter block and a cylindrical portion insertable into the through-hole of the connector block and the diameter expansion portion of the header side pipe.

7. The pipe connecting structure of claim 1, wherein
the top portion of the vehicle side pipe is formed by an adapter connected with the vehicle side pipe and having a large diameter portion for preventing the adapter to pass through the connecter block and a cylindrical portion insertable into the through-hole of the connector block and the diameter expansion portion of the header side pipe.
